(19) United States
(12) Patent Application Publication
(10) Pub. No.: US 2012/0195439 A1
(43) Pub. Date: Aug. 2, 2012

(54) ACTIVE VIBRATION NOISE CONTROL DEVICE

(75) Inventors: Yoshiki Ohta, Sakado (JP); Manabu Nohara, Tsurugashima (JP); Yusuke Soga, Kawasaki (JP); Kensaku Obata, Kawasaki (JP); Akihiro Iseki, Kawasaki (JP)

(73) Assignee: PIONEER CORPORATION, Kanagawa (JP)

(21) Appl. No.: 13/499,790

(22) PCT Filed: Oct. 7, 2009
(86) PCT No.: PCT/JP2009/067466

§ 371 Date: Apr. 9, 2012

(51) Int. Cl. G10K 11/16

(52) U.S. Cl. 381/71.4

(57) ABSTRACT

An active vibration noise control device is preferably used for cancelling a vibration noise by making a speaker generate a control sound. The active vibration noise control device includes a step-size parameter changing unit which changes a step-size parameter used for updating a filter coefficient. The step-size parameter changing unit calculates a parameter-for-change based on the filter coefficient updated by using a basic step-size parameter, and changes the basic step-size parameter by a minimum value in the previously calculated parameter-for-change. Therefore, it is possible to appropriately change the step-size parameter by using the minimum value of the parameter-for-change. Hence, it becomes possible to effectively suppress a divergence of an adaptive notch filter due to a secular change of the speaker.

### TECHNICAL FIELD

The present invention relates to a technical field for actively controlling a vibration noise by using an adaptive notch filter.

### BACKGROUND TECHNIQUE

Conventionally, there is proposed an active vibration noise control device for controlling an engine sound heard in a vehicle interior by a controlled sound output from a speaker so as to decrease the engine sound at a position of passenger's ear. Concretely, noticing that a vibration noise in a vehicle interior is generated in synchronization with a revolution of an output axis of an engine, there is proposed a technique for cancelling the noise in the vehicle interior on the basis of the revolution of the output axis of the engine by using an adaptive notch filter so that the vehicle interior becomes silent.

This kind of technique is proposed in Patent Reference 1, for example. In Patent Reference 1, there is proposed a technique for changing a step-size parameter (in other words, step gain) used for updating a filter coefficient of the adaptive notch filter in accordance with an output amplitude of the adaptive notch filter.

### Prior Art Reference

### Patent Reference

Patent Reference-1: Japanese Patent Application Laid-open under No. 2000-990037

### DISCLOSURE OF INVENTION

### Problem to be Solved by the Invention

However, by the above technique in Patent Reference 1, there is a case that the step-size parameter cannot be changed to an appropriate value due to an error (especially a phase error) of a transfer function caused by a secular change of the speaker, and that the adaptive notch filter diverges.

The present invention has been achieved in order to solve the above problem. It is an object of the present invention to provide an active vibration noise control device capable of effectively suppressing a divergence of an adaptive notch filter.

### Means for Solving the Problem

In the invention according to claim 1, an active vibration noise control device for canceling a vibration noise by making a speaker output a control sound, includes: a basic signal generating unit which generates a basic signal based on a vibration noise frequency generated by a vibration noise source; an adaptive notch filter which generates a control signal provided to the speaker by applying a filter coefficient to the basic signal, in order to make the speaker generate the control sound so that the vibration noise generated by the vibration noise source is cancelled; a microphone which detects a cancellation error between the vibration noise and the control sound, and outputs an error signal; a reference signal generating unit which generates a reference signal from the basic signal based on a transfer function from the speaker to the microphone; a filter coefficient updating unit which updates the filter coefficient used by the adaptive notch filter based on the error signal and the reference signal so as to minimize the error signal; and a step-size parameter changing unit which changes a step-size parameter used for updating the filter coefficient by the filter coefficient updating unit, wherein the step-size parameter changing unit includes a parameter-for-change calculating unit which calculates a parameter-for-change used for changing the step-size parameter based on the filter coefficient updated by using a basic step-size parameter, and wherein the step-size parameter changing unit determined a value which is obtained by changing the basic step-size parameter by a minimum value in the parameter-for-change previously calculated by the parameter-for-change calculating unit, as the step-size parameter used for updating the filter coefficient.

### BRIEF DESCRIPTION OF THE DRAWINGS

FIG. 1 is a configuration of an active vibration noise control device in an embodiment.

FIG. 2 shows an example of a normal update using a basic step-size parameter.

FIG. 3 shows a diagram for explaining a method for calculating a parameter-for-change.

FIG. 4 is a flow chart showing a change process of a step-size parameter.

FIGS. 5A and 5B show result examples by an embodiment and a first comparative example.

FIGS. 6A and 6B show result examples by an embodiment and a second.

### DETAILED DESCRIPTION OF THE PREFERRED EMBODIMENTS

According to one aspect of the present invention, there is provided an active vibration noise control device for canceling a vibration noise by making a speaker output a control sound, including: a basic signal generating unit which generates a basic signal based on a vibration noise frequency generated by a vibration noise source; an adaptive notch filter which generates a control signal provided to the speaker by applying a filter coefficient to the basic signal, in order to make the speaker generate the control sound so that the vibration noise generated by the vibration noise source is cancelled; a microphone which detects a cancellation error between the vibration noise and the control sound, and outputs an error signal; a reference signal generating unit which generates a reference signal from the basic signal based on a transfer function from the speaker to the microphone; a filter coefficient updating unit which updates the filter coefficient used by the adaptive notch filter based on the error signal and the reference signal so as to minimize the error signal; and a step-size parameter changing unit which changes a step-size parameter used for updating the filter coefficient by the filter coefficient updating unit, wherein the step-size parameter changing unit includes a parameter-for-change calculating unit which calculates a parameter-for-change used for changing the step-size parameter based on the filter coefficient updated by using a basic step-size parameter, and wherein the step-size parameter changing unit determined a value which is obtained by changing the basic step-size parameter by a minimum value in the parameter-for-change previously calculated by the parameter-for-change calculating unit, as the step-size parameter used for updating the filter coefficient.

The above active vibration noise control device is preferably used for cancelling the vibration noise by making the speaker generate the control sound. The basic signal generating unit generates the basic signal based on the vibration noise frequency generated by the vibration noise source. The adaptive notch filter generates the control signal provided to the speaker by applying the filter coefficient to the basic signal. The microphone detects the cancellation error between the vibration noise and the control sound, and outputs the error signal. The reference signal generating unit generates the reference signal from the basic signal based on the transfer function from the speaker to the microphone. The filter coefficient updating unit updates the filter coefficient used by the adaptive notch filter so as to minimize the error signal. Then, the step-size parameter changing unit changes the step-size parameter used for updating the filter coefficient. In detail, the step-size parameter changing unit calculates the parameter-for-change based on the filter coefficient updated by using the basic step-size parameter, and changes the basic step-size parameter by the minimum value in the previously calculated parameter-for-change. Therefore, it is possible to appropriately change the step-size parameter by using the minimum value of the parameter-for-change. Hence, it becomes possible to effectively suppress the divergence of the adaptive notch filter due to the secular change of the speaker.

In a manner of the above active vibration noise control device, the parameter-for-change calculating unit calculates an output amplitude of the adaptive notch filter based on the filter coefficient updated by using the basic step-size parameter, and calculates the parameter-for-change having a value which decreases with an increase in the output amplitude.

According to the manner, the parameter-for-change calculating unit calculates the parameter-for-change based on the output amplitude of the adaptive notch filter correlated with an error between the transfer functions. Therefore, it is possible to calculate the parameter-for-change in accordance with the error between the transfer functions. Hence, it becomes possible to suppress the divergence of the adaptive notch filter more effectively.

In another manner of the above active vibration noise control device, the parameter-for-change calculating unit sets the parameter-for-change to a constant value when the output amplitude is smaller than a predetermined value, and the parameter-for-change calculating unit calculates the parameter-for-change having the value which decreases with the increase in the output amplitude when the output amplitude is equal to or larger than the predetermined value. By using the predetermined value, it becomes possible to suppress changing the step-size parameter when it can be said that there is little error between the transfer functions.

In another manner of the above active vibration noise control device, the parameter-for-change calculating unit does not set the parameter-for-change to a value which is smaller than a predetermined value. By using the predetermined value, when the relatively large error between the transfer functions occurs, it is possible to fix the step-size parameter to an appropriate value, whereby it becomes possible to stabilize the system.

In a preferred example of the above active vibration noise control device, when there are plural speakers, the step-size parameter changing unit can change the step-size parameter for each of the plural speakers.

### Embodiment

Preferred embodiment of the present invention will be explained hereinafter with reference to the drawings.

[Device Configuration]

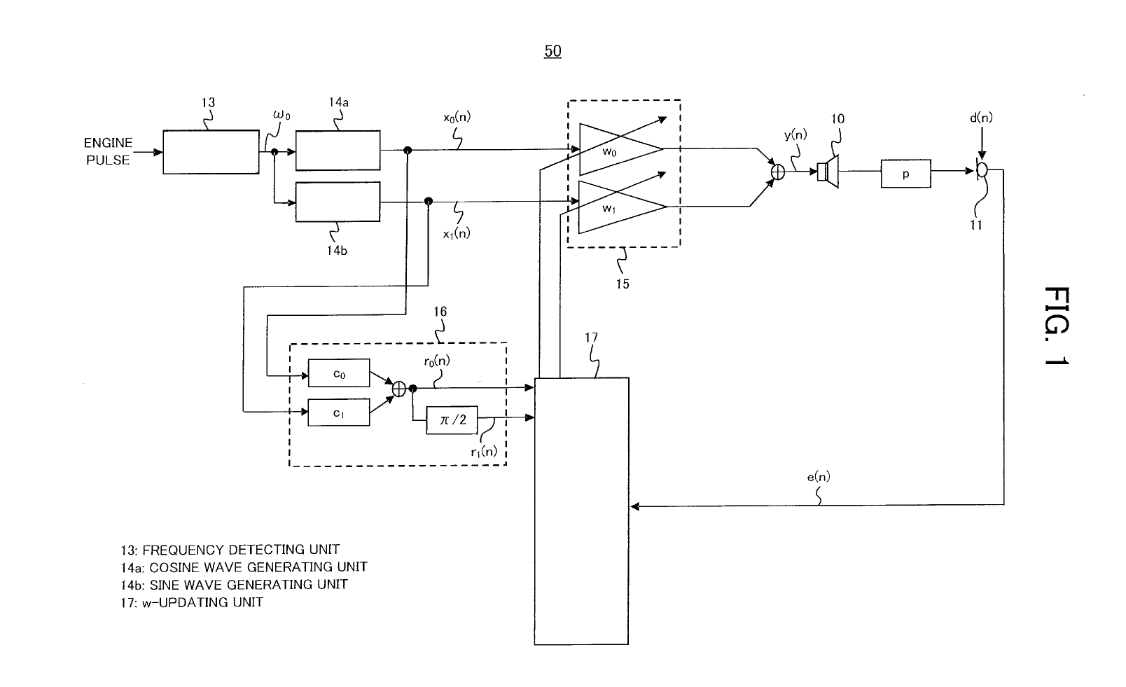

FIG. 1 shows a configuration of an active vibration noise control device 50 in an embodiment. The active vibration noise control device 50 includes a speaker 10, a microphone 11, a frequency detecting unit 13, a cosine wave generating unit 14a, a sine wave generating unit 14b, an adaptive notch filter 15, a reference signal generating unit 16 and a w-updating unit 17.

The active vibration noise control device 50 is mounted on a vehicle. For example, the speaker 10 is installed in a right front door in the vehicle, and the microphone 11 is installed over a driver's head. Basically, the active vibration noise control device 50 makes the speaker 10 generate the control sounds based on the frequency in accordance with the revolution of the engine output axis so as to actively control the vibration noise of the engine as the vibration noise source. Concretely, the active vibration noise control device 50 feeds back the error signal detected by the microphone 11 and minimizes the error by using the adaptive notch filter so as to actively control the vibration noise.

A description will be given of the components of the active vibration noise control device 50. The frequency detecting unit 13 is supplied with an engine pulse and detects a frequency ω₀ of the engine pulse. Then, the frequency detecting unit 13 supplies the cosine wave generating unit 14a and the sine wave generating unit 14b with a signal corresponding to the frequency ω₀.

The cosine wave generating unit 14a and the sine wave generating unit 14b generate a basic cosine wave x₀(n) and a basic sine wave x₁(n) which include the frequency ω₀ detected by the frequency detecting unit 13. Concretely, as shown by equations (1) and (2), the cosine wave generating unit 14a and the sine wave generating unit 14b generate the basic cosine wave x₀(n) and the basic sine wave x₁(n). In the equations (1) and (2), “n” is natural number and corresponds to time (The same will apply hereinafter). Additionally, “A” indicates amplitude, and “φ” indicates an initial phase.

x₀(n)=A cos (ω₀n+φ) (1)

x₁(n)=A sin (ω₀n+φ) (2)

Then, the cosine wave generating unit 14a and the sine wave generating unit 14b supply the adaptive notch filter 15 and the reference signal generating unit 16 with basic signals corresponding to the basic cosine wave x₀(n) and the basic sine wave x₁(n). Thus, the cosine wave generating unit 14a and the sine wave generating unit 14b function as the basic signal generating unit.

The adaptive notch filter 15 performs the filter process of the basic cosine wave x₀(n) and the basic sine wave x₁(n), so as to generate the control signal y(n) supplied to the speaker 10. Concretely, the adaptive notch filter 15 generates the control signal y(n) based on the filter coefficients w₀(n) and w₁(n) inputted from the w-updating unit 17. Specifically, as shown by equation (3), the adaptive notch filter 15 adds a value obtained by multiplying the basic cosine wave x₀(n) by the filter coefficient w₀(n), to a value by multiplying the basic sine wave x₁(n) by the filter coefficient w₁(n), so as to calculate the control signal y(n). Hereinafter, when the filter coefficients w₀(n) and w₁(n) are used with no distinction, the filter coefficients wₒ(n) and w₁(n) are represented by “filter coefficient w”.

y(n)=w₀(n)x₀(n)+w₁(n)x₁(n) (3)

The speaker 10 generates the control sound corresponding to the control signal y (n) inputted from the adaptive notch filter 15. The control sound generated by the speaker 10 is transferred to the microphone 11. A transfer function from the speaker 10 to the microphone 11 is represented by “p”. The transfer function p is defined by frequency ω₀, and depends on the sound field characteristic and the distance from the speaker 10 to the microphone 11. The transfer function P from the speaker 10 to the microphone 11 is preliminary set by a measurement.

The microphone 11 detects the cancellation error between the vibration noise of the engine and the control sound generated by the speaker 10, and supplies the w-updating unit 17 with the cancellation error as the error signal e(n). Concretely, the microphone 11 outputs the error signal e(n) in accordance with the control signal y(n), the transfer function p and the vibration noise d(n) of the engine.

The reference signal generating unit 16 generates the reference signal from the basic cosine wave x₀(n) and the basic sine wave x₁(n) based on the above transfer function p, and supplies the w-updating unit 17 with the reference signal. Concretely, the reference signal generating unit 16 uses a real part c₀ and an imaginary part c₁ of the transfer function p. Specifically, the reference signal generating unit 16 adds a value obtained by multiplying the basic cosine wave x₀(n) by the real part c₀ of the transfer function p, to a value obtained by multiplying the basic sine wave x₁(n) by the imaginary part c₁ of the transfer function p, and outputs a value obtained by the addition as the reference signal r₀(n). In addition, the reference signal generating unit 16 delays the reference signal r₀(n) by “n/2”, and outputs the delayed signal as the reference signal r₁(n). Thus, the reference signal generating unit 16 functions as the reference signal generating unit.

The w-updating unit 17 updates the filter coefficient used by the adaptive notch filter 15 based on the LMS (Least Mean Square) algorism, and supplies the adaptive notch filter 15 with the updated filter coefficient. Concretely, the w-updating unit 17 updates the filter coefficient used by the adaptive notch filter 15 last time so as to minimize the error signal e(n), based on the error signal e(n) and the reference signals r₀(n), r₁(n). The filter coefficient after the update is represented by “w₀(n+1)” and “w₁(n+1)”, and the filter coefficient before the update is represented by “w₀(n)” and “w₀(n)”. As shown by equations (4) and (5), the filter coefficients after the update w₀(n+1) and w₁(n+1) are calculated.

w₀(n+1)=w₀(n)−μ′·e(n)·r₀(n) (4)

w₁(n+1)=w₁(n)−μ′·e(n)·r₁(n) (5)

In equations (4) and (5), “μ′” is a predetermined constant called a step-size parameter for determining a convergence speed. Specifically, the step-size parameter μ′ is obtained by changing a step-size parameter μ as a basis (hereinafter referred to as “basic step-size parameter μ”). As described later in detail, in the embodiment, the w-updating unit 17 calculates the step-size parameter μ′ by changing the basic step-size parameter μ, and updates the filter coefficient based on the step-size parameter μ′. Thus, the w-updating unit 17 functions as the step-size parameter changing unit.

[Method for Changing Step-Size Parameter]

Next, a concrete description will be given of a method for changing the step-size parameter in the embodiment.

First, a description will be given of a reason for changing the step-size parameter. As described above, the transfer function p from the speaker 10 to the microphone 11 is used when the reference signal is calculated. Basically, the transfer function p is preliminary set, and is not changed. However, there is a tendency that an actual transfer function of a sound field from the speaker 10 to the microphone 11 is constantly changed. For example, the actual transfer function is changed by a secular change of the speaker 10 and passengers. When the actual transfer function is changed, an error (especially phase error) between the preliminarily set transfer function p and the actual transfer function occurs. Hereinafter, the error between the transfer functions due to the secular change of the speaker 10 is referred to as “transfer function error”.

Since the reference signal calculated by the transfer function p is used for calculating the filter coefficient (see the equations (4) and (5)), there is a tendency that the filter coefficient diverges when the above transfer function error occurs. Namely, it can be said that the adaptive notch filter tends to diverge.

Therefore, in the embodiment, the step-size parameter is changed, and the filter coefficient is updated by the changed step-size parameter, so as to suppress the divergence of the adaptive notch filter due to the transfer function error. Concretely, since it is difficult to appropriately know the transfer function error, the step-size parameter is changed based on an output amplitude of the adaptive notch filter which indicates a condition of the transfer function error, in the embodiment.

A concrete description will be given of a procedure for changing the step-size parameter. First, the w-updating unit 17 updates the filter coefficient by using the basic step-size parameter. Concretely, by using equations in which “μ′” in the equations (4) and (5) is replaced by “μ”, the w-updating unit 17 calculates the filter coefficients w₀(n+1) and w₁(n+1). Hereinafter, the above update is referred to as “normal update”. The basic step-size parameter μ is a constant value.

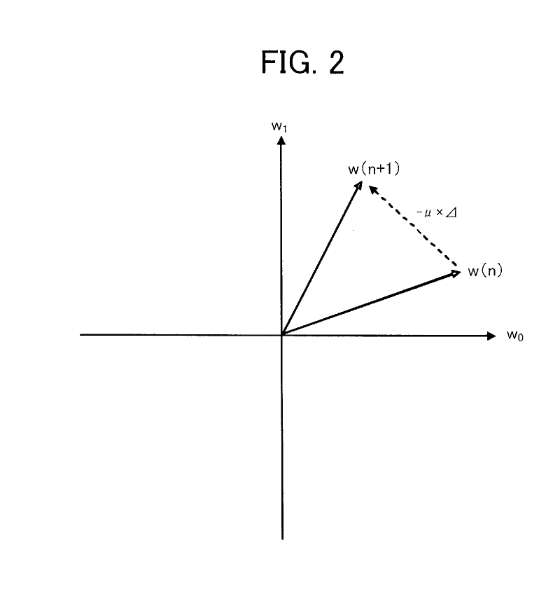

FIG. 2 shows an example of the normal update using the basic step-size parameter μ. In FIG. 2, a horizontal axis shows the filter coefficient w₀ used for the basic cosine wave x₀, and a vertical axis shows the filter coefficient w₁ used for the basic sine wave x₁. Additionally, in FIG. 2, “w(n)” indicates a vector defined by the filter coefficients w₀(n) and w₁(n) before the update, and “w(n+1)” indicates a vector defined by the filter coefficients w₀(n+1) and w₁(n+1) after the update. As shown by a broken arrow in FIG. 2, it can be understood that the filter coefficient w(n) is updated to filter coefficient w(n+1) by the basic step-size parameter μ.

Next, the w-updating unit 17 calculates the output amplitude of the adaptive notch filter from the filter coefficients w₀(n+1) and w₁(n+1) after the normal update. Concretely, if the output amplitude is expressed as “ww”, the output amplitude ww is calculated by a sum of squares of the filter coefficients w₀(n+1) and w₁(n+1), as shown by an equation (6).

ww={w₀(n+1)}²+{wₗ(n+1)}² (6)

It is not limited to use the sum of squares of the filter coefficients w₀(n+1) and w₁(n+1), as the output amplitude ww. As another example, the square root of the sum of squares of the filter coefficients w₀(n+1) and w₁(n+1) can be used as the output amplitude ww.

Next, the w-updating unit 17 calculates a parameter (hereinafter referred to as “parameter-for-change α”) used for changing the step-size parameter, based on the output amplitude ww. Basically, the w-updating unit 17 calculates the parameter-for-change α having a value which decreases with an increase in the output amplitude ww.

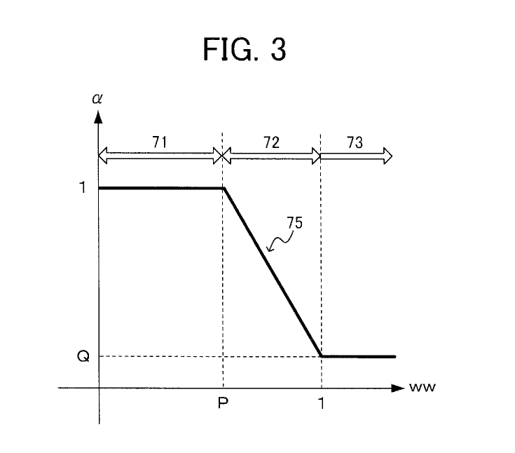

FIG. 3 shows a diagram for concretely explaining a method for calculating the parameter-for-change α. In FIG. 3, a horizontal axis shows the output amplitude ww, and a vertical axis shows the parameter-for-change α. As shown by an arrow 71, when the output amplitude ww is equal to or smaller than a predetermined value P (ww≦P), the parameter-for-change α is set to “1”. When the step-size parameter μ, is calculated by using “1” as the parameter-for-change α, the step-size parameter μ′ becomes the same value as the basic step-size parameter μ. Therefore, the update of the filter coefficient by using the step-size parameter μ′ becomes similar to the normal update.

The predetermined value P is set based on a maximum value of a control signal level when there is not the transfer function error (namely, when the active vibration noise control device 50 is normally used). By using the above predetermined value P, it becomes possible to suppress changing the step-size parameter μ′ wastefully when it can be said that there is little transfer function error.

Additionally, as shown by an arrow 72, when the output amplitude ww is larger than the predetermined value P and the output amplitude ww is equal to or smaller than “1” (P<ww≦1), the parameter-for-change α having the value which decreases with the increase in the output amplitude ww is calculated. Concretely, as shown by an arrow 75, the parameter-for-change α is linearly decreased with the increase in the output amplitude ww. Specifically, the parameter-for-change α is decreased within a range from “1” to a predetermined value Q. In this case, the w-updating unit 17 calculates the parameter-for-change α by an equation (7)

α=(1−Q)/(P−1)×ww+(PQ−1)/(P−1) (7)

Additionally, as shown by an arrow 73, when the output amplitude ww is larger than “1” (ww>1), the parameter-for-change α is set to the predetermined value Q. Namely, the parameter-for-change α is not set to a value which is smaller than the predetermined value Q. The predetermined value Q is set based on a step-size parameter capable of stabilizing the system when a maximum transfer function error ensured in a manufacturing occurs. Therefore, when the relatively large transfer function error occurs, it is possible to set the step-size parameter μ′ to an appropriate value, whereby it becomes possible to stabilize the system.

It is not limited to decrease the parameter-for-change α linearly in accordance with the output amplitude ww, as shown by the arrow 75 in FIG. 3. As another example, the parameter-for-change α can be decreased by a quadratic function in accordance with the output amplitude ww. As still another example, without decreasing the parameter-for-change α continuously, the parameter-for-change α can be decreased in a step-by-step manner in accordance with the output amplitude ww.

Next, the w-updating unit 17 determines the step-size parameter μ′ used for finally updating the filter coefficient, based on the parameter-for-change α calculated by the above manner. Concretely, the w-updating unit 17 changes the basic step-size parameter μ based on a minimum value of the parameter-for-change α from the time of starting the system (in other words, the minimum value of the parameter-for-change α from the time of booting the system. Hereinafter, the minimum value is referred to as “minimum parameter-for-change αₘᵢₙ”), and determines the changed basic step-size parameter μ as the step-size parameter μ′. Namely, without changing the step-size parameter μ′ with each cycle by the parameter-for-change α calculated this time, the w-updating unit 17 changes the step-size parameter μ′ by the minimum value αₘᵢₙ in the previously calculated parameter-for-change α. This is because, since the step-size parameter μ′ is changed in accordance with the change of the parameter-for-change α when the step-size parameter μ′ is changed by the parameter-for-change α with each calculation of the parameter-for-change α, the divergence of the adaptive notch filter is not appropriately suppressed.

In this case, as shown by an equation (8), the w-updating unit 1 determines a value obtained by multiplying the basic step-size parameter μ by the minimum parameter-for-change αₘᵢₙ, as the step-size parameter μ′. An initial value of the minimum parameter-for-change αₘᵢₙ is set to “1”.

μ′=αₘᵢₙ^{x}μ (8)

Specifically, by comparing the parameter-for-change α calculated this time with the minimum parameter-for-change αₘᵢₙ (namely, the minimum value in the previously calculated parameter-for-change α), the w-updating unit 17 determines whether or not to update the minimum parameter-for-change αₘᵢₙ by the parameter-for-change α. In detail, when the parameter-for-change α calculated this time is smaller than the minimum parameter-for-change αₘᵢₙ, the w-updating unit 17 updates the minimum parameter-for-change αₘᵢₙ by the parameter-for-change α. Namely, the w-updating unit 17 sets the minimum parameter-for-change αₘᵢₙ to the parameter-for-change α calculated this time. In this case, the w-updating unit 17 changes the basic step-size parameter μ by the parameter-for-change α calculated this time, and determines the changed basic step-size parameter μ as the step-size parameter μ′ used for updating the filter coefficient.

Meanwhile, when the parameter-for-change α calculated this time is equal to or larger than the minimum parameter-for-change αₘᵢₙ, the w-updating unit 17 does not change the minimum parameter-for-change αₘᵢₙ. In this case, the w-updating unit 17 changes the basic step-size parameter μ by the minimum parameter-for-change αₘᵢₙ (namely, the w-updating unit 17 changes the basic step-size parameter μ by the minimum value in the previously calculated parameter-for-change α), and determines the changed basic step-size parameter μ as the step-size parameter μ′ used for updating the filter coefficient.

Then, the w-updating unit 17 updates the filter coefficient by using the above determined step-size parameter μ′. While the above example shows that the filter coefficient is updated by using the equations (4) and (5), it is not necessary to actually perform the calculation related to the equations (4) and (5). This is because, since the calculation of the normal update using the basic step-size parameter μ is already performed (namely, the calculation related to the equations in which “μ′” in the equations (4) and (5) is replaced by “μ” is already performed), it is possible to calculate the updated filter coefficient from the step-size parameter μ′ by using a value obtained by the normal update. Therefore, it is possible to reduce the calculation process.

By the method for changing the step-size parameter according to the above embodiment, it is possible to appropriately change the step-size parameter μ′ by using the minimum parameter-for-change αₘᵢₙ. Therefore, it becomes possible to effectively suppress the divergence of the adaptive notch filter due to the transfer function error caused by the secular change of the speaker 10.

[Change Process of Step-Size Parameter]

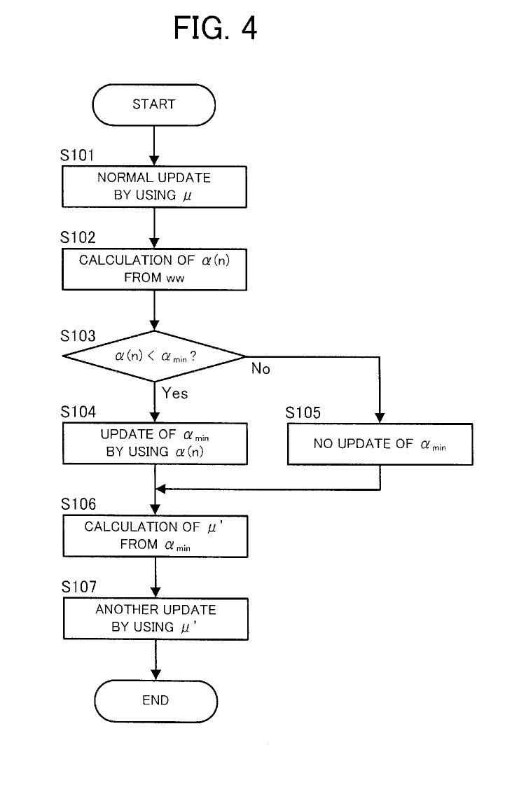

Next, a description will be given of a change process of the step-size parameter, with reference to FIG. 4. FIG. 4 is a flowchart showing the change process of the step-size parameter. This process is repeatedly executed by the w-updating unit 17 in a predetermined cycle.

First, in step S101, the w-updating unit 17 updates the filter coefficient by using the basic step-size parameter μ. Namely, the w-updating unit 17 performs the normal update. Then, the process goes to step S102.

Instep S102, the w-updating unit 17 calculates the output amplitude ww of the adaptive notch filter from the filter coefficient after the normal update, and calculates the parameter-for-change α based on the output amplitude ww. For example, the w-updating unit 17 calculates the parameter-for-change α in accordance with the relationship between the output amplitude ww and the parameter-for-change α as shown in FIG. 3. Then, the process goes to step S103.

In step S103, the w-updating unit 17 determines whether or not the parameter-for-change α calculated in step S102 is smaller than the minimum parameter-for-change αₘᵢₙ. When the parameter-for-change α is smaller than the minimum parameter-for-change αₘᵢₙ (step S103: Yes), the process goes to step S104. In this case, the w-updating unit 17 updates the minimum parameter-for-change αₘᵢₙ by the parameter-for-change α (step S104), and the process goes to step S106.

Meanwhile, when the parameter-for-change α is equal to or larger than the minimum parameter-for-change αₘᵢₙ (step S103: No), the process goes to step S105. In this case, the w-updating unit 17 does not update the minimum parameter-for-change αₘᵢₙ by the parameter-for-change α (step S105). Then, the process goes to step S106.

In step S106, the w-updating unit 17 calculates the step-size parameter μ′ based on the minimum parameter-for-change αₘᵢₙ. Concretely, as shown by the equation (8), the w-updating unit 17 determines the value obtained by multiplying the basic step-size parameter μ by the minimum parameter-for-change αₘᵢₙ, as the step-size parameter μ′. Then, the process goes to step S107.

In step S107, the w-updating unit 17 updates the filter coefficient again, based on the step-size parameter μ′ calculated in step S106. Then, the process ends.

### Effect of Embodiment

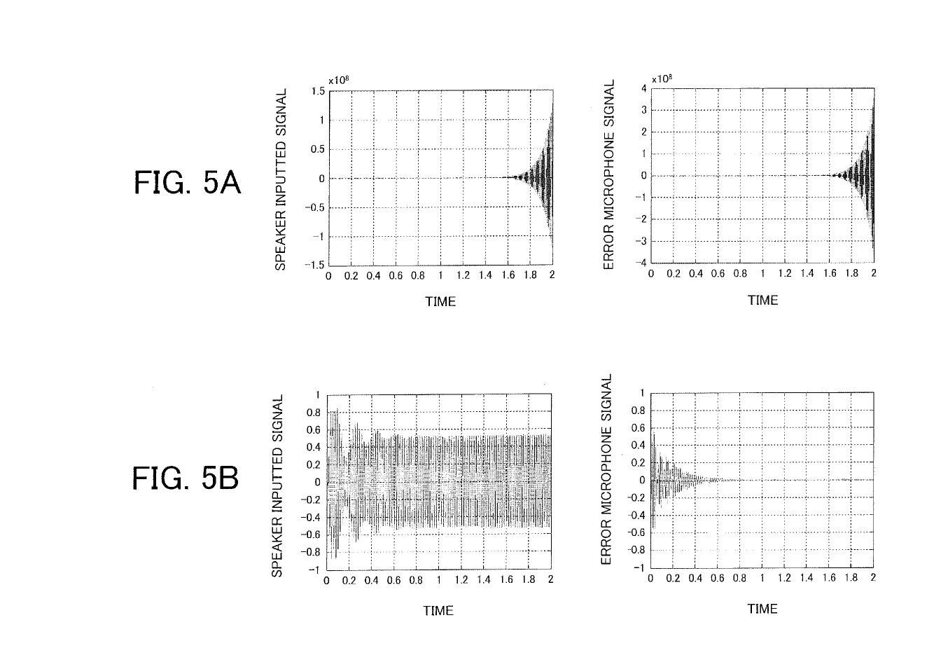

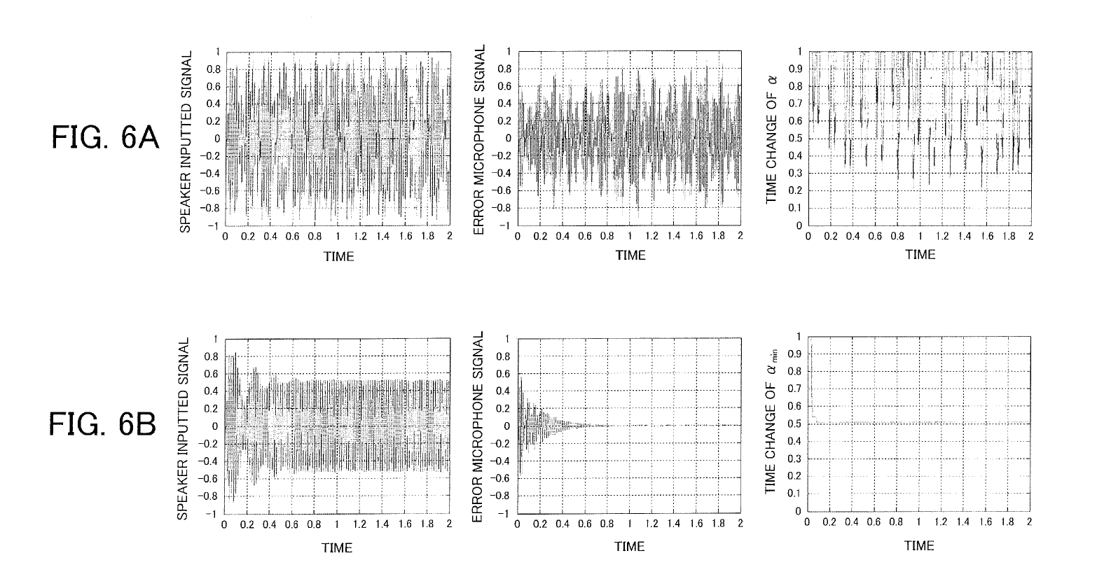

Next, a description will be given of an effect of the embodiment, with reference to FIGS. 5A and 5B, and FIGS. 6A and 6B. Here, the embodiment is compared with an example (hereinafter referred to as “first comparative example”) in which the step-size parameter μ′ is not changed. Namely, in the first comparative example, the filter coefficient is continuously updated by only using the basic step-size parameter μ. Additionally, the embodiment is compared with an example (hereinafter referred to as “second comparative example”) in which the step-size parameter μ′ is continuously changed by the parameter-for-change α without using the minimum parameter-for-change αₘᵢₙ.

FIGS. 5A and 5B show result examples by the embodiment and the first comparative example. The result examples are obtained when a constant noise having 50 [Hz] is used and a phase error between the transfer functions is set to 60 degrees, in such a condition that the speaker 10 is installed in the right front door and the microphone 11 is installed over the driver's head.

FIG. 5A shows an example of a result by the first comparative example. Concretely, in FIG. 5A, a time change of a speaker inputted signal (corresponding to y(n)) is shown on a left side, and a time change of an error microphone signal is shown on a right side. A scale of a vertical axis in FIG. 5A is significantly large. As shown in FIG. 5A, it can be understood that an amplitude of speaker inputted signal significantly changes and the error microphone signal does not converge. Namely, it can be said that the vibration noise in the vehicle interior is not appropriately suppressed. It is thought that this phenomenon is caused by the divergence of the adaptive notch filter due to the transfer function error.

FIG. 5B shows an example of a result by the embodiment. Concretely, in FIG. 5B, a time change of a speaker inputted signal (corresponding to y(n)) is shown on a left side, and a time change of an error microphone signal is shown on a right side. As shown in FIG. 5B, it can be understood that an amplitude of speaker inputted signal approximately becomes constant and the error microphone signal converges. Namely, it can be said that the vibration noise in the vehicle interior is appropriately suppressed. It is thought that this is because the divergence of the adaptive notch filter is appropriately suppressed by appropriately changing the step-size parameter μ′.

Next, FIGS. 6A and 6B show result examples by the embodiment and the second comparative example. The result examples are obtained when a constant noise having 50 [Hz] is used and a phase error between the transfer functions is set to 60 degrees, in such a condition that the speaker 10 is installed in the right front door and the microphone 11 is installed over the driver's head, too.

FIG. 6A shows an example of a result by the second comparative example . Concretely, in FIG. 6A, a time change of a speaker inputted signal (corresponding to y(n)) is shown on a left side, and a time change of an error microphone signal is shown in a center, and a time change of the parameter-for-change α is shown on a right side. As shown in FIG. 6A, it can be understood that an amplitude of speaker inputted signal significantly changes and the error microphone signal does not converge. Namely, it can be said that the vibration noise in the vehicle interior is not appropriately suppressed. It is thought that this is because, since the step-size parameter μ′ is significantly changed in accordance with the change of the parameter-for-change α as shown on the right side in FIG. 6A, the divergence of the adaptive notch filter is not appropriately suppressed.

FIG. 6B shows an example of a result by the embodiment. Concretely, in FIG. 6B, a time change of a speaker inputted signal (corresponding to y(n)) is shown on a left side, and a time change of an error microphone signal is shown in a center, and a time change of the minimum parameter-for-change αₘᵢₙ is shown on a right side. As shown in FIG. 6B, it can be understood that an amplitude of speaker inputted signal approximately becomes constant and the error microphone signal converges. Namely, it can be said that the vibration noise in the vehicle interior is appropriately suppressed. It is thought that this is because, since the step-size parameter μ′ is appropriately changed by the minimum parameter-for-change αₘᵢₙ as shown on the right side in FIG. 6B and the step-size parameter μ′ converges on a fixed value quickly, the divergence of the adaptive notch filter is appropriately suppressed.

[Modification]

It is not limited to apply the present invention to the active vibration noise control device 50 having only one speaker 10. The present invention can be applied to an active vibration noise control device having plural speakers. In this case, the step-size parameter μ′ may be changed for each of the plural speakers. Namely, the output amplitude ww may be calculated for each of the plural speakers, and the minimum parameter-for-change αₘᵢₙ may be individually calculated, so as to change the step-size parameter μ′.

Additionally, it is not limited that the present invention is applied to the vehicle. Other than the vehicle, the present invention can be applied to various kinds of transportation such as a ship or a helicopter or an airplane.

### INDUSTRIAL APPLICABILITY

This invention is applied to closed spaces such as an interior of transportation having a vibration noise source (for example, engine), and can be used for actively controlling a vibration noise.

### DESCRIPTION OF REFERENCE NUMBERS

10 Speaker

11 Microphone

13 Frequency Detecting Unit

14a Cosine Wave Generating Unit

14b Sine Wave Generating Unit

15 Adaptive Notch Filter

16 Reference Signal Generating Unit

17 w-Updating Unit

50 Active Vibration Noise Control Device

1. An active vibration noise control device for canceling a vibration noise by making a speaker output a control sound, comprising:
a basic signal generating unit which generates a basic signal based on a vibration noise frequency generated by a vibration noise source;
an adaptive notch filter which generates a control signal provided to the speaker by applying a filter coefficient to the basic signal, in order to make the speaker generate the control sound so that the vibration noise generated by the vibration noise source is cancelled;
a microphone which detects a cancellation error between the vibration noise and the control sound, and outputs an error signal;
a reference signal generating unit which generates a reference signal from the basic signal based on a transfer function from the speaker to the microphone;
a filter coefficient updating unit which updates the filter coefficient used by the adaptive notch filter based on the error signal and the reference signal so as to minimize the error signal; and
a step-size parameter changing unit which changes a step-size parameter used for updating the filter coefficient by the filter coefficient updating unit,
wherein the step-size parameter changing unit includes a parameter-for-change calculating unit which calculates a parameter-for-change used for changing the step-size parameter based on the filter coefficient updated by using a basic step-size parameter, and
wherein the step-size parameter changing unit determined a value which is obtained by changing the basic step-size parameter by a minimum value in the parameter-for-change previously calculated by the parameter-for-change calculating unit, as the step-size parameter used for updating the filter coefficient.

2. The active vibration noise control device according to claim 1,
wherein the parameter-for-change calculating unit calculates an output amplitude of the adaptive notch filter based on the filter coefficient updated by using the basic step-size parameter, and calculates the parameter-for-change having a value which decreases with an increase in the output amplitude.

3. The active vibration noise control device according to claim 2,
wherein, when the output amplitude is smaller than a predetermined value, the parameter-for-change calculating unit sets the parameter-for-change to a constant value, and
wherein, when the output amplitude is equal to or larger than the predetermined value, the parameter-for-change calculating unit calculates the parameter-for-change having the value which decreases with the increase in the output amplitude.

4. The active vibration noise control device according to claim 3,
wherein the parameter-for-change calculating unit does not set the parameter-for-change to a value which is smaller than a predetermined value.

5. The active vibration noise control device according to claim 1,
wherein, when there are plural speakers, the step-size parameter changing unit changes the step-size parameter for each of the plural speakers.
